(19) United States
(12) Patent Application Publication
(10) Pub. No.: US 2023/0417106 A1
(43) Pub. Date: Dec. 28, 2023

(54) FOLDABLE IRON LADDER

(71) Applicant: Luhao LENG, Xiamen City (CN)

(72) Inventor: Luhao LENG, Xiamen City (CN)

(21) Appl. No.: 17/988,056

(22) Filed: Nov. 16, 2022

(30) Foreign Application Priority Data
Jun. 23, 2022 (CN) 202221590506.9

(51) Int. Cl. E06C 1/393; E06C 7/18

(52) U.S. Cl. CPC E06C 1/393; E06C 7/182

(57) ABSTRACT

A foldable iron ladder comprises two front leg pipes, two rear leg pipes, a stand platform, and a climbing platform. Two sides of a front portion of the stand platform are pivotally connected to the two front leg pipes. Two sides of a middle portion of the stand platform are pivotally connected to first ends of two connecting pieces. Second ends of the two connecting pieces are pivotally connected to the two rear leg pipes. The climbing platform is located below the stand platform. The climbing platform is connected between the two front leg pipes. The climbing platform comprises a flanged edge extending along all sides thereof in an enclosed shape and extending downward greater than 2 centimeters. The climbing platform and the two front leg pipes are made of iron and are welded together. When in an opened state, the stand platform and the climbing platform are horizontally arranged.

### RELATED APPLICATIONS

This application claims priority to Chinese patent application number 202221590506.9, filed on Jun. 23, 2022. Chinese patent application number 202221590506.9 is incorporated herein by reference.

### FIELD OF THE DISCLOSURE

The present disclosure relates to a foldable ladder, and in particular to a foldable iron ladder.

### BACKGROUND OF THE DISCLOSURE

Since stability of a foldable ladder defines safety of using the foldable ladder, the stability of the foldable ladder is a most concerning point for consumers when the consumers purchase such products. When the consumers purchase the foldable ladder in the supermarket, the stability of the foldable can be tested easily by stepping on a platform of the foldable ladder directly.

Through surveying the consumers, satisfaction for the stability of the foldable ladder is not strong enough for the consumers. A main reason for this phenomenon is that, except for front and rear positions of a top platform, the other platforms are simply connected to leg pipes through connecting pieces, so that sides of the other platforms can be said to be connected to the leg tubes through bearing a single point of force. Once a heavy consumer steps on these platforms, although the platforms shake slightly, for the consumers who climb up the top platform, this shaking will increase with the increase of a center of gravity, so the consumers' feeling is obvious.

### BRIEF SUMMARY OF THE DISCLOSURE

The present disclosure provides a foldable iron ladder to improve stability thereof. In order to solve the technical problem, a technical solution of the present disclosure is as follows.

A foldable iron ladder comprises two front leg pipes parallel to each other in a left-and-right direction, two rear leg pipes parallel to each other in the left-and-right direction, a stand platform, and one or more climbing platforms. Each of the two front leg pipes and a corresponding one of the two rear leg pipes on a same side are pivotally connected to each other in a splayed shape. Two sides of a front portion of the stand platform are pivotally connected to the two front leg pipes, and two sides of a middle portion of the stand platform are pivotally connected to first ends of two connecting pieces respectively. Second ends of the two connecting pieces are pivotally connected to the two rear leg pipes respectively. A connecting rod is connected between the two rear leg pipes for supporting the stand platform. The one or more climbing platforms are located below the stand platform. The one or more climbing platforms are connected between the two front leg pipes. Each of the one or more climbing platforms comprises a flanged edge extending along all sides thereof in an enclosed shape. A height of the flanged edge is larger than 2 centimeters. The one or more climbing platforms and the two front leg pipes are made of iron. The flanged edge is welded to the two front leg pipes. When the stand platform and the one or more climbing platforms are in an opened state, the stand platform and the one or more climbing platforms are horizontally arranged, and the stand platform is supported on the connecting rod.

The flanged edge extends downward at least 2 centimeters so that the flanged edge can be firmly welded to the two front leg pipes and a welding space is large to form an elongated welding line to prevent shaking of the one or more climbing platforms. Furthermore, a rear side of the stand platform can be supported by the connecting rod when the foldable iron ladder is in the opened state, so that whether a user steps on the stand platform or on the one or more climbing platforms, stability and safety of the foldable iron ladder can be ensured.

In a preferred embodiment, a front side and a rear side of each of the two front leg pipes are respectively welded to the flanged edge. Two sides of each of the two front leg pipes are welded to the flanged edge to have a longer length of the elongate welding line, and the elongated welding line can fill up a gap between the flanged edge and the two front leg pipes.

In a preferred embodiment, a rear side of a bottom portion of the stand platform is disposed with an elastic rotating locking buckle, and the elastic rotating locking buckle is locked to the connecting rod when the stand platform is in the opened state. The locking connection between the elastic rotating locking buckle and the connecting rod enable stability of the stand platform when the stand platform is in the opened state.

In a preferred embodiment, the flanged edge comprises one or more through holes. Since the flanged edge is made of iron, the one or more through holes enable liquid to flow out after the flanged edge is processed for rust protection such as electrophoresis.

In a preferred embodiment, the two front leg pipes cover the one or more through holes. The one or more through holes cannot be seen when the one or more through holes are aligned with one or two of the two front leg pipes.

In a preferred embodiment, the foldable iron ladder further comprises a U-shaped handrail, and two ends of the U-shaped handrail are respectively connected to the two front leg pipes in an insertion member.

In a preferred embodiment, a top end of each of the two front leg pipes is disposed with a sleeve, and a top end of each of the two rear leg pipes is pivotally connected to the sleeve.

In a preferred embodiment, spacers are disposed at a pivoting position between the two sides of the front portion of the stand platform and the two front leg pipes.

### BRIEF DESCRIPTION OF THE DRAWINGS

FIG. 1 illustrates a first perspective view of a foldable iron ladder.

FIG. 2 illustrates a second perspective view of the foldable iron ladder.

FIG. 3 illustrates an exploded view of the foldable iron ladder in FIG. 1.

FIG. 4 illustrates a side view of the foldable iron ladder in FIG. 1.

FIG. 5 illustrates a perspective view of the foldable iron ladder when the foldable iron ladder is in an opened state.

### DETAILED DESCRIPTION OF THE EMBODIMENTS

The present disclosure will be further described below in combination with the accompanying drawings and embodiments.

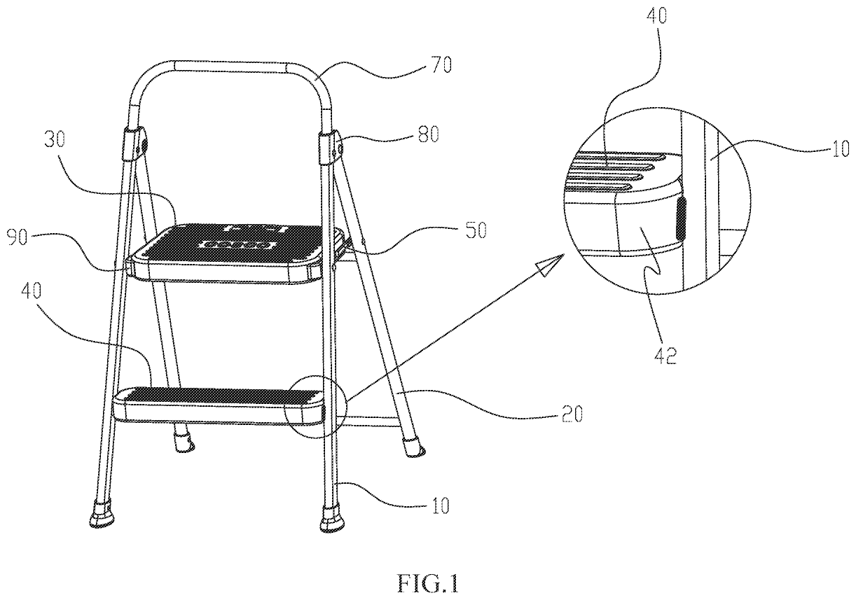

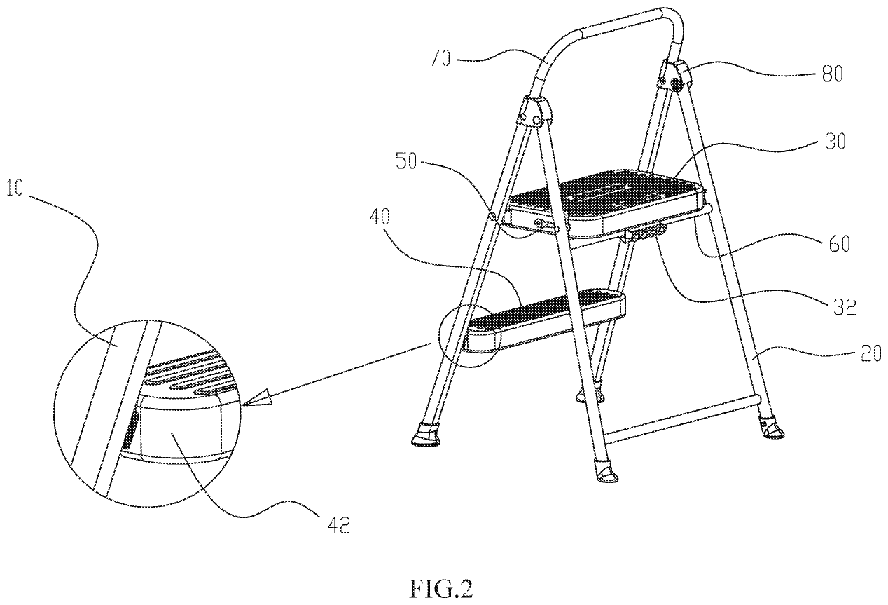

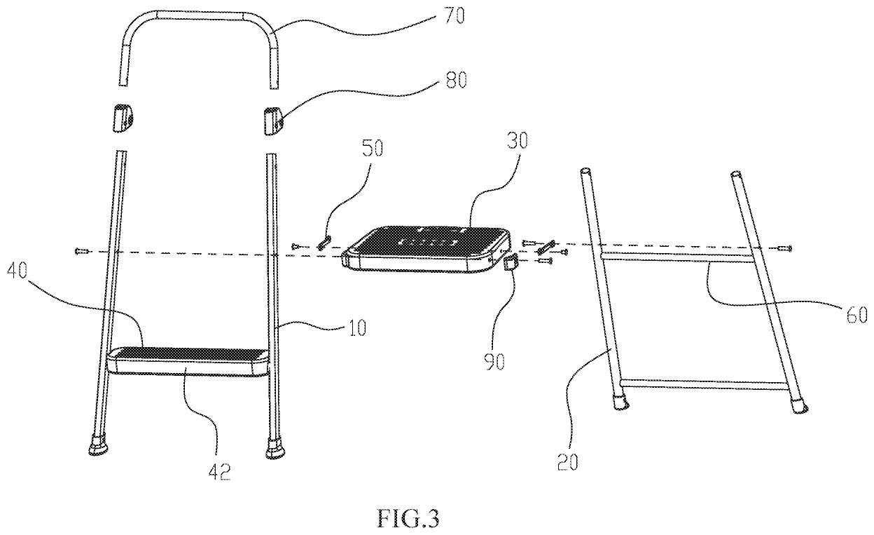

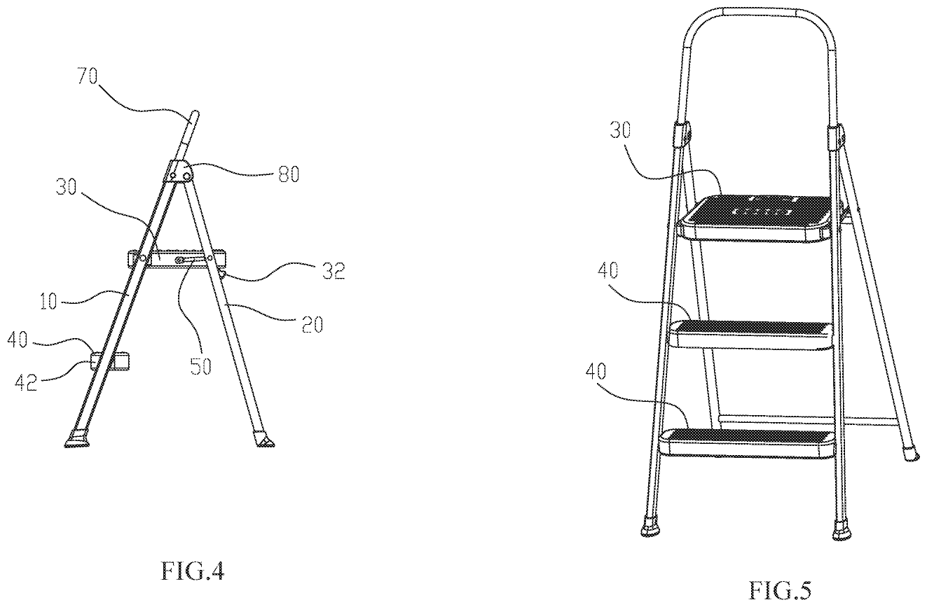

Referring to FIG. 1 to FIG. 4, a foldable iron ladder comprises two front leg pipes 10 parallel to each other in a left-and-right direction, two rear leg pipes 20 parallel to each other in the left-and-right direction, a stand platform 30, and one or more climbing platforms 40. Each of the two front leg pipes 10 and a corresponding one of the two rear leg pipes 20 on a same side are pivotally connected to each other in a splayed shape to achieve unfolding and folding. The stand platform 30 is located on an upper portion of the foldable iron ladder, and the one or more climbing platforms 40 are located below the stand platform 30. It can be understood that the one or more climbing platforms 40 can be a single climbing platform 40 or a plurality of climbing platforms 40. Referring to FIG. 5 for example, when there is a need for increasing a height of the foldable iron ladder, the number of the one or more climbing platforms 40 can be increased for a user climbing up the one or more climbing platforms 40 step-by-step so as to arrive at the stand platform 30.

Two sides of a front portion of the stand platform 30 are pivotally connected to the two front leg pipes 10, two sides of a middle portion of the stand platform 30 are pivotally connected to first ends of two connecting pieces 50 respectively, and second ends of the two connecting pieces 50 are pivotally connected to the two rear leg pipes 20 respectively. Existing technology can be referenced regarding mechanism principles of the above-mentioned structures.

A connecting rod 60 is connected between the two rear leg pipes 20 for supporting the stand platform 30. The one or more climbing platforms 40 are connected between the two front leg pipes 10. Each of the one or more climbing platforms 40 comprises a flanged edge 42 extending along all sides thereof in an enclosed shape, and a height of the flanged edge 42 is larger than 2 centimeters. The one or more climbing platforms 40 and the two front leg pipes 10 are made of iron. In this embodiment, the two rear leg pipes 20 and the stand platform 30 are also made of iron. The flanged edge 42 is welded to the two front leg pipes 10, and an elongated welding line is formed at a welding position between the flanged edge 42 and the two front leg pipes 10. When the stand platform 30 and the one or more climbing platforms 40 are in an opened state, the stand platform 30 and the one or more climbing platforms 40 are horizontally arranged, and the stand platform 30 is supported on the connecting rod 60. Since the one or more climbing platforms 40 are horizontally arranged when in the opened state, the one or more climbing platforms 40 are welded to the two front leg pipes 10 in an inclined state.

Preferably, a front side and a rear side of each of the two front leg pipes 10 are respectively welded to the flanged edge 42.

Preferably, a rear side of a bottom portion of the stand platform 30 is disposed with an elastic rotating locking buckle 32, and the elastic rotating locking buckle 32 is locked to the connecting rod 60 when the stand platform is in the opened state.

Preferably, the flanged edge 42 comprises one or more through holes, and the one or more through holes are located on a left side and a right side of the flanged edge 42, so that the two front leg pipes 10 can cover the one or more through holes.

Preferably, the foldable iron ladder further comprises a U-shaped handrail 70, and two ends of the U-shaped handrail 70 are respectively connected to the two front leg pipes 10 in an insertion member.

Preferably, a top end of each of the two front leg pipes 10 is disposed with a sleeve 80, and a top end of each of the two rear leg pipes 20 is pivotally connected to the sleeve 80.

Preferably, spacers 90 are disposed at a pivoting position between the two sides of the front portion of the stand platform 30 and the two front leg pipes 10.

In this embodiment, rivets are used for a pivoting connection between the stand platform 30 and the two front leg pipes, a pivoting connection between the stand platform and the two connecting pieces 50, and a pivoting connection between the two connecting pieces 50 and the rear leg pipes.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A foldable iron ladder, comprising:
two front leg pipes parallel to each other in a left-and-right direction,
two rear leg pipes parallel to each other in the left-and-right direction,
a stand platform, and
one or more climbing platforms, wherein:
each of the two front leg pipes and a corresponding one of the two rear leg pipes on a same side are pivotally connected to each other in a splayed shape,
two sides of a front portion of the stand platform are pivotally connected to the two front leg pipes,
two sides of a middle portion of the stand platform are pivotally connected to first ends of two connecting pieces respectively,
second ends of the two connecting pieces are pivotally connected to the two rear leg pipes respectively,
a connecting rod is connected between the two rear leg pipes for supporting the stand platform,
the one or more climbing platforms are located below the stand platform,
the one or more climbing platforms are connected between the two front leg pipes,
each of the one or more climbing platforms comprises a flanged edge extending along all sides thereof in an enclosed shape,
a height of the flanged edge is larger than 2 centimeters,
the one or more climbing platforms and the two front leg pipes are made of iron,
the flanged edge is welded to the two front leg pipes, and
when the stand platform and the one or more climbing platforms are in an opened state:
the stand platform and the one or more climbing platforms are horizontally arranged, and
the stand platform is supported on the connecting rod.

2. The foldable iron ladder according to claim 1, wherein:
a front side and a rear side of each of the two front leg pipes are respectively welded to the flanged edge.

3. The foldable iron ladder according to claim 1, wherein:
a rear side of a bottom portion of the stand platform is disposed with an elastic rotating locking buckle, and the elastic rotating locking buckle is locked to the connecting rod when the stand platform is in the opened state.

4. The foldable iron ladder according to claim 1, wherein:
the flanged edge comprises one or more through holes.

5. The foldable iron ladder according to claim 4, wherein:
the two front leg pipes cover the one or more through holes.

6. The foldable iron ladder according to claim 1, wherein:
the foldable iron ladder further comprises a U-shaped handrail, and
two ends of the U-shaped handrail are respectively connected to the two front leg pipes in an insertion member.

7. The foldable iron ladder according to claim 6, wherein:
a top end of each of the two front leg pipes is disposed with a sleeve, and
a top end of each of the two rear leg pipes is pivotally connected to the sleeve.

8. The foldable iron ladder according to claim 1, wherein:
spacers are disposed at a pivoting position between the two sides of the front portion of the stand platform and the two front leg pipes.

9. The foldable iron ladder according to claim 2, wherein:
a rear side of a bottom portion of the stand platform is disposed with an elastic rotating locking buckle, and the elastic rotating locking buckle is locked to the connecting rod when the stand platform is in the opened state.

10. The foldable iron ladder according to claim 2, wherein:
the flanged edge comprises one or more through holes.
